(19) United States
(12) Patent Application Publication
(10) Pub. No.: US 2026/0008183 A1
(43) Pub. Date: Jan. 8, 2026

(54) ROBOT-BASED ELECTRIC VEHICLE PARKING AND CHARGING MANAGEMENT APPARATUS AND METHOD

(71) Applicants: HYUNDAI MOTOR COMPANY, Seoul (KR); KIA CORPORATION, Seoul (KR); SUNGSHIN WOMEN’S UNIVERSITY R&DB FOUNDATION, Seoul (KR)

(72) Inventors: Won Hee Kim, Hwaseong-si (KR); Soomin Shim, Hwaseong-si (KR); Jaehoon You, Hwaseong-si (KR); Hyo Jin Song, Incheon (KR); Yujin Song, Dongducheon-si (KR); Namgyo Kim, Chuncheon-si (KR); Sihyeon Park, Chungju-si (KR); Seong Wook Hwang, Seoul (KR); Joon Young Kim, Seoul (KR); Jeong Min Oh, Seoul (KR)

(73) Assignees: HYUNDAI MOTOR COMPANY, Seoul (KR); KIA CORPORATION, Seoul (KR); SUNGSHIN WOMEN’S UNIVERSITY R&DB FOUNDATION, Seoul (KR)

(21) Appl. No.: 18/953,962

(22) Filed: Nov. 20, 2024

(30) Foreign Application Priority Data
Jul. 8, 2024 (KR) 10-2024-0089346

(51) Int. Cl. B25J 9/16; B25J 11/00; B60L 53/36

(52) U.S. Cl. CPC B25J 9/1679; B25J 11/008; B60L 53/36

(57) ABSTRACT

A robot-based electric vehicle parking and charging management apparatus includes a parking robot configured to move a vehicle dropped off in a drop-off zone to a parking zone or a charging zone. The apparatus also includes a charging robot configured to charge the vehicle moved by the parking robot to the charging zone by connecting a charger. The apparatus also includes a controller configured to control a movement of the parking robot or an operation of the charging robot, according to a parking request or a charging request of a user of the vehicle.

### CROSS-REFERENCE TO RELATED APPLICATION

This application claims the priority to and the benefit of Korean Patent Application No. 10-2024-0089346 filed in the Korean Intellectual Property Office on Jul. 8, 2024, the entire contents of which are incorporated herein by reference.

### TECHNICAL FIELD

The present disclosure relates to a robot-based electric vehicle parking and charging management apparatus and a robot-based electric vehicle parking and charging management method. More particularly, the present disclosure relates to a robot-based electric vehicle parking and charging management apparatus and a robot-based electric vehicle parking and charging management method capable of automatizing parking and charging management of electric vehicles by using a robot.

### BACKGROUND

Currently, electric vehicle users have to wait to use a charger or find another charger.

Currently, car sharing companies guide users to park in front of the charger and start charging. Accordingly, when the parking space capable of providing charging is insufficient, charging is not possible or must be done later by a manager. When the charging is not done by the manager, the vehicle may not be charged afterwards, and the charged level may be insufficient when a subsequent user picks up the vehicle.

Generally, when using a car sharing service, the user or manager must directly settle the charging fee with the charging card in the vehicle, and although electric vehicle charging is partially automated using a manipulator, etc., in some cases, full automation is difficult.

Electric vehicle chargers, such as mobile manipulators, are not suitable as an automation solution because the electric vehicle chargers cannot be operated all the time or require the purchase of additional robots. The subject matter described in this background section is intended to promote an understanding of the background of the disclosure and thus may include subject matter that is not already known to those of ordinary skill in the art.

### SUMMARY

The present disclosure aims to provide a robot-based electric vehicle parking and charging management apparatus and a robot-based electric vehicle parking and charging management method. According to the apparatus and the method, when charging of the vehicle being charged in the charging zone is completed, a charging robot removes the charger, and a parking robot replaces the vehicle with a subsequent vehicle.

The present disclosure aims to provide a robot-based electric vehicle parking and charging management apparatus and a robot-based electric vehicle parking and charging management method. According to the apparatus and the method, when a vehicle is parked at corresponding parking space through a parking robot, a charging robot approaches the charging inlet position of the vehicle according to approximate vehicle specifications and parking direction information, and the charger is inserted into the vehicle charging inlet by utilizing vision or a sensor.

The present disclosure aims to provide a robot-based electric vehicle parking and charging management apparatus and a robot-based electric vehicle parking and charging management apparatus method. According to the apparatus and the method, a parking robot is configured to pick up and move the vehicle from drop-off zone based on vehicle information to drop off the vehicle in a parking zone, and the parking robot is charged by the charger of the charging zone when the parking robot is not working.

A robot-based electric vehicle parking and charging management apparatus may include a parking robot configured to move a vehicle dropped off in a drop-off zone to a parking zone or a charging zone. The apparatus may also include a charging robot configured to charge the vehicle moved by the parking robot to the charging zone by connecting a charger. The apparatus may also include a controller configured to control a movement of the parking robot or an operation of the charging robot, according to a parking request or a charging request of a user of the vehicle.

The parking robot may load the vehicle dropped off in the drop-off zone; move to a parking space arranged in the parking zone; may unload the vehicle in the parking space; and may return to the drop-off zone.

The parking robot may be configured to transport the vehicle completed with charging in the charging zone to the parking zone; and may transport the vehicle requiring charging from the parking zone to the charging zone.

When the vehicle is dropped off in the charging zone, the charging robot may be configured to approach a position of a charging inlet of the vehicle based on information on the vehicle received from a database; and may insert the charger into the charging inlet of the vehicle by using a sensor.

When an entry of the vehicle into the drop-off zone is detected through a sensor module, the controller may be configured to determine whether the vehicle is able to be dropped off and dispose the parking robot when determining that the vehicle is able to be dropped off.

When the vehicle entering the drop-off zone is detected, the controller may be configured to determine whether the vehicle is registered for the service. When the vehicle is not registered, the controller may be configured to determine vehicle information including type and specifications of the non-registered vehicle from a database and determine whether the non-registered vehicle is able to be dropped off based on the vehicle information.

When the vehicle is registered for the service, the controller may be configured to determine that the registered vehicle is able to be dropped off and determine whether there is a remaining parking space within the parking zone usable by the registered vehicle based on registered vehicle information on the registered vehicle and parking zone map information.

When a remaining parking space for the registered vehicle and the non-registered vehicle is determined, the controller may be configured to dispose the parking robot to each of the registered vehicle and the non-registered vehicle. When the remaining parking space for the registered vehicle and the non-registered vehicle is not determined, the controller may be configured to inform a delay time to dispose the parking robot to the user.

The controller may be configured to determine a state of charge (SoC) with respect to first pick-up vehicles reserved for pick-up within a preset time among all vehicles within a service region. The controller may be configured to charge a second pick-up vehicle having the state of charge (SoC) lower than a preset first minimum reference value among the preset first pick-up vehicles to the first minimum reference value.

When the second pick-up vehicle is not detected, the controller may be configured to determine the state of charge (SoC) with respect to all vehicles within the service region and charge a vehicle having the state of charge (SoC) lower than a preset second minimum reference value among all vehicles to the preset second minimum reference value.

A robot-based electric vehicle parking and charging management method may include detecting, by a sensor, a vehicle entering a drop-off zone. The method may also include determining whether the vehicle is able to be dropped off. The method may also include moving, by a parking robot, the vehicle determined to be able to be dropped off to a parking zone or a charging zone. The method may also include moving, by using the parking robot, the vehicle parked in the parking zone to the charging zone. The method may also include charging, by a charging robot, a vehicle disposed in the charging zone by connecting a charger. The method may also include returning, by the parking robot, a vehicle completed with charging to the parking zone.

A robot-based electric vehicle parking and charging management method may further include receiving a drop-off request in the drop-off zone with respect to a user vehicle input through an interface of an application from a user terminal.

Determining whether the vehicle is able to be dropped off may include determining whether the vehicle is registered for a service. Determining whether the vehicle is able to be dropped off may further include determining vehicle information including type and specifications of the vehicle from a database and determining whether the vehicle is able to be dropped off based on the vehicle information, when the vehicle is not registered for the service.

Determining whether the vehicle is able to be dropped off may further include determining that the vehicle is able to be dropped off, when the vehicle is registered for the service. Determining whether the vehicle is able to be dropped off may further include determining whether there is a remaining parking space within the parking zone usable by the registered vehicle based on registered vehicle information on the registered vehicle and parking zone map information.

Moving, by the parking robot, the vehicle to the parking zone or the charging zone may include moving the vehicle to the charging zone when the charger of the charging zone is usable and moving the vehicle to the parking zone when the charger of the charging zone is not usable.

The robot-based electric vehicle parking and charging management method may further include identifying whether there is a parking space for the vehicle in the parking zone when it is determined that the vehicle is able to be dropped off. The method may further include disposing the parking robot to the vehicle when there is the parking space. The method may further include informing a delay time to dispose the parking robot with respect to the vehicle when there is no parking space.

The robot-based electric vehicle parking and charging management method may further include determining a state of charge (SoC) with respect to first pick-up vehicles reserved for pick-up within a preset time among all vehicles within a service region. The method may further include charging a second pick-up vehicle having the state of charge (SoC) lower than a preset first minimum reference value among the first pick-up vehicles to the preset first minimum reference value.

The robot-based electric vehicle parking and charging management method may further include determining the state of charge (SoC) with respect to all vehicles within the service region, when the second pick-up vehicle is not detected. The method may further include charging a vehicle having the state of charge (SoC) lower than a preset second minimum reference value among the all vehicles to the preset second minimum reference value.

Moving, by the parking robot, the vehicle to the parking zone or the charging zone may include loading the vehicle dropped off in the drop-off zone by the parking robot; moving the parking robot to a parking space within the parking zone arranged for the vehicle; and unloading the vehicle in the parking space.

Charging, by the charging robot, the vehicle disposed in the charging zone to the charger by connecting the charger may include receiving vehicle information including type and specifications of the vehicle from a database by the charging robot; detecting a position of a charging inlet of the vehicle based on the vehicle information by the charging robot; and inserting the charger into the charging inlet by using a sensor by the charging robot.

A robot-based electric vehicle parking and charging management apparatus and a robot-based electric vehicle parking and charging management method according to an embodiment provide an electric vehicle unmanned charging and settlement solution to a parking space. The apparatus and the method may cope with a high charging demand, and a parking space management company can maximize the number of electric vehicle chargers and may minimize the cost by using the present disclosure.

By providing an electric vehicle unmanned charging and settlement solution, in providing a car sharing or rental service, a robot-based electric vehicle parking and charging management apparatus and a robot-based electric vehicle parking and charging management method according to an embodiment may ensure a sufficient state of charge (SoC) of the electric vehicle before usage and may minimize the need for additional charging infrastructure secure through unmanned solutions.

### BRIEF DESCRIPTION OF THE DRAWINGS

FIG. 1 schematically shows a robot-based electric vehicle parking and charging management system according to an embodiment.

FIG. 2 is a block diagram of a robot-based electric vehicle parking and charging management apparatus according to an embodiment.

FIG. 3 is a block diagram of a robot-based electric vehicle parking and charging management apparatus according to another embodiment of the present disclosure.

FIG. 4 is a drawing showing a service zone including a drop-off zone, a parking zone, and a charging zone according to an embodiment.

FIG. 5 is a flowchart of a robot-based electric vehicle parking and charging management method according to an embodiment.

FIG. 6 is a flowchart of a robot-based electric vehicle parking and charging management method according to an embodiment.

FIGS. 7-10 are drawings for explaining a robot-based electric vehicle parking and charging management method according to an embodiment.

FIG. 11 is a drawing for explaining a computing device according to an embodiment.

### DETAILED DESCRIPTION

Embodiments of the present disclosure are described more fully hereinafter with reference to the accompanying drawings such that those having ordinary skill in the art may easily implement the embodiments. Those having ordinary skill in the art should understand that the described embodiments may be modified in various different ways, without departing from the spirit or scope of the present disclosure. In order to clarify the present disclosure, parts that are not related to the descriptions have been omitted, and the same elements or equivalents are denoted with the same reference numerals throughout the present disclosure.

In addition, unless explicitly described to the contrary, the term “comprise” and variations, such as “comprises” or “comprising,” should be understood to include stated elements without excluding any other elements. Terms including ordinal numbers, such as first and second, are used for describing various constituent elements, but the constituent elements are not limited by the terms. The terms are only used to differentiate one component from other components. In addition, the terms “unit”, “part”, “portion”, “-er”, and “module” in the specification refer to a unit that processes at least one function or operation, which may be implemented by hardware, software, or a combination of hardware and software. When a controller, module, component, device, element, unit, part, portion, “-er”, or the like of the present disclosure is described as having a purpose or performing an operation, function, or the like, the controller, module, component, device, element, unit, part, portion, “-er”, or the like should be considered herein as being “configured to” meet that purpose or to perform that operation or function. Each controller, module, component, device, element, unit, part, portion, “-er”, and the like may separately embody or be included with a processor and a memory, such as a non-transitory computer readable media, as part of the apparatus.

Hereinafter, embodiments of the present disclosure are described with reference to the drawings.

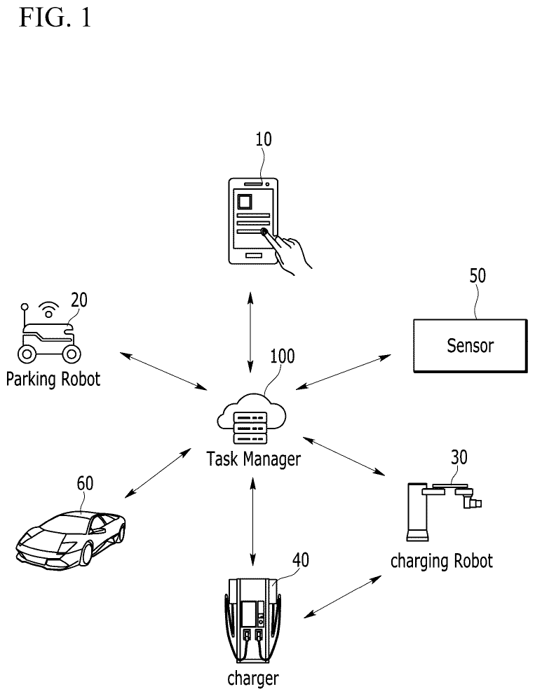

FIG. 1 schematically shows a robot-based electric vehicle parking and charging management system according to an embodiment. FIG. 1 shows a communication protocol between components of a robot-based electric vehicle parking and charging management system.

Referring to FIG. 1, a robot-based electric vehicle parking and charging management system may include a user terminal 10, a parking robot 20, a charging robot 30, a charger 40, a sensor 50, a vehicle 60, and a controller 100.

The robot-based electric vehicle parking and charging management system may provide an automated parking and charging service of a personal or business vehicle.

The user terminal 10 may include a smartphone, tablet, computer, kiosk, etc. The user terminal 10 may provide an interface necessary for using the service to the user through an application or web. In other words, the user terminal 10 may provide the environment capable of using the service to the user.

The parking robot 20 may move the vehicle 60 within a parking area and/or a charging area. The parking robot 20 may park the vehicle 60 in the parking area. The parking robot 20 may dispose the vehicle 60 in the charging area. The parking robot 20 may return the vehicle 60 to the user.

For example, the parking robot 20 may provide the service according to the parking position and the specification of the vehicle.

The charging robot 30 may connect the vehicle 60 to the charger 40. The charging robot 30 may provide the service according to a position of the charger and a position of the charging inlet. The status of starting and completing charging may be informed to the controller 100.

The charger 40 is not particularly limited and may mean all types of electric vehicle charging facilities. The charger 40 may include both of a fast charger and a slow charger. The charger 40 may be linked to a charging fee settlement system. The charger 40 may transfer the state of charge (SoC) of the vehicle to the controller 100.

The charger 40 may be directly connected to the controller 100 through the network. Alternatively, the charger 40 may communicate with the controller 100 through the charging robot 30. The charger 40 may be linked to the user terminal 10. The charger 40 may communicate with the user terminal 10 through the controller 100.

The sensor 50 may detect a movement or motion of a person or object within a service providing area. For example, the sensor 50 may determine whether a person or object has entered or exited from a workspace. The type of the sensor 50 may include a light curtain, a vision solution, or the like and is not particularly limited.

The vehicle 60 may include all types of vehicles that can use the parking and charging service. The vehicle 60 may include an electric vehicle.

The controller 100 may be connected to the user terminal 10, the parking robot 20, the charging robot 30, the charger 40, the sensor 50, and the vehicle 60 through a wired or wireless network.

The controller 100 may perform various controls required for the service, such as charging and parking works and log management, maintaining vehicle information, vehicle waiting management, parking lot map management, emergency control, or the like.

The controller 100 may respond to a request for service provision request the user terminal 10, may exchange data with the parking robot 20, the charging robot 30, and a sensor 40, and may perform an integrate control required for providing the service based on data.

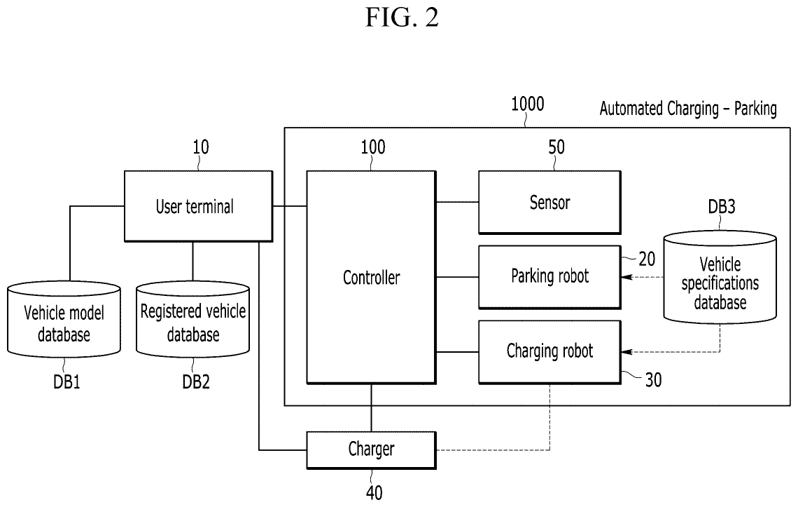

FIG. 2 is a block diagram of a robot-based electric vehicle parking and charging management apparatus according to an embodiment.

FIG. 2 shows a block diagram with respect to a robot-based electric vehicle parking and charging management apparatus according to an embodiment that provides a robot-based unmanned parking and charging service with respect to a normal vehicle.

In FIG. 2, robot-based electric vehicle parking and charging management apparatus 1000 can automate the parking and charging service of vehicles within a service area or a service zone by using the parking robot 20, the charging robot 30, and the charger 40.

The user may request the service through interface of the user terminal 10 and may drop-off the vehicle at the designated position.

For example, an initial user may register the user's vehicle for the unmanned parking and charging service through the interface (i.e., user interface) of the user terminal 10. The initial user may input a type, number plate, or the like of the user's vehicle, for vehicle registration.

The robot-based electric vehicle parking and charging management apparatus 1000 may utilize user's input content and a public database to update a registered vehicle database DB2. The registered vehicle database DB2 may include registration information for the registered vehicles in order to identify the registered vehicles. The registered vehicle database DB2 may include the vehicle information including vehicle specifications for the registered vehicle.

The robot-based electric vehicle parking and charging management apparatus 1000 may utilize a vehicle model database DB1 to determine whether the service may be provided to the vehicle entering the service zone.

The vehicle model database DB1 may include the vehicle information including vehicle types, specification, and vehicle specifications based on the vehicle model with respect to vehicles completed with the vehicle registration.

The vehicle model database DB1 may include information on whether the service with respect to the registered vehicle may be provided based on the vehicle information.

The user may reserve pick-up of the parked vehicle or request it at a desired time point through the interface of the user terminal 10.

The robot-based electric vehicle parking and charging management apparatus 1000 may guide the user to settle the charging fee after charging, through the charger 40 connected to the user terminal 10 through a network. In other words, the user may pay the usage fee and/or charging fee through the interface of the user terminal 10 at the time point of the vehicle pick-up.

Referring to FIG. 2, the robot-based electric vehicle parking and charging management apparatus 1000 according to an embodiment may include the parking robot 20, the charging robot 30, the sensor 50, a vehicle specifications database DB3, and the controller 100.

The parking robot 20 may move a user's vehicle dropped off in a drop-off zone to a parking zone or a charging zone.

The parking robot 20 may load the vehicle dropped off in the drop-off zone and may move to a parking space arranged in the parking zone.

The parking robot 20 may unload the vehicle in the parking space and may return to the drop-off zone.

The parking robot 20 may transport the vehicle completed with charging in the charging zone to the parking zone and may transport the electric vehicle requiring charging in the parking zone to the charging zone.

The charging robot 30 may charge the vehicle moved to the charging zone by the parking robot by connecting the charger.

When the vehicle is dropped off in the charging zone, the charging robot 30 may approach the position of the charging inlet of the vehicle based on information on the vehicle received from the database.

The charging robot 30 may insert the charger into the charging inlet of the vehicle by using a sensor.

The sensor 50 may include all types of sensors disposed within the service zone. For example, the sensor 50 may detect entry and exit of a person or object into and from the parking zone, the charging zone, and the drop-off zone of the service zone, which are workspaces. For example, the sensor may include a light curtain, vision solution, or the like.

The vehicle specifications database DB3 may store vehicle specifications data with respect to the registered vehicle or dedicated vehicle. When the vehicle detected to enter the drop-off zone is determined to be the registered vehicle, the vehicle specifications database DB3 may provide specifications data with respect to the registered vehicle.

For example, the specifications data may include information on an interval between wheels and the position/angle of the charging inlet of that vehicle type.

The vehicle specifications database DB3 may also include specifications data with respect to a vehicle that is not registered.

According to the user's parking request and charging request, the controller 100 may integratedly control the movement of the parking robot and the operation of the charging robot. The controller 100 may be a task manager with respect to the parking robot and the charging robot.

When the entry of the vehicle into the drop-off zone is detected through a sensor module, the controller 100 may determine whether the vehicle may be dropped off, and when the drop-off is determined, the controller 100 may dispose the parking robot.

When a vehicle entering the drop-off zone is detected, the controller 100 may determine whether the detected vehicle has been registered for the service.

In the case of the non-registered vehicle that is not registered, the controller 100 may determine the vehicle information including type and specifications of the non-registered vehicle from the database and may determine whether the drop-off is possible based on the vehicle information.

Here, the database may be the vehicle model database DB1 or the vehicle specifications database DB3.

In the case of the registered vehicle that is registered for the service, the controller 100 may determine that the drop-off is possible and may determine whether there is a remaining parking space within the parking zone that may be used by the registered vehicle based on the registered vehicle information on the registered vehicle.

The registered vehicle information may be determined from the registered vehicle database DB2.

When the remaining parking space for the registered vehicle and the non-registered vehicle is determined, the controller 100 may dispose the parking robot to each of the registered vehicle and the non-registered vehicle.

When the remaining parking space is not determined, the controller 100 may inform a delay time to disposal of the parking robot to the user.

The controller 100 may determine the remaining parking space through the camera sensor and the parking zone map information disposed in the parking zone. For example, the controller 100 may identify the remaining parking space customized for the vehicle based on the vehicle specifications included in the vehicle information and the parking space information included in the parking zone map information.

The controller 100 may determine the state of charge (SoC) with respect to first pick-up vehicles reserved for pick-up within preset time among all vehicles within a service region.

The controller 100 may desirably charge a second pick-up vehicle of which the state of charge (SoC) is lower than a preset first minimum reference value among the first pick-up vehicles to the first minimum reference value.

When the second pick-up vehicle is not detected, the controller 10 may determine the state of charge (SoC) with respect to all vehicles within the service region.

The controller 100 may desirably charge a specific vehicle having the state of charge (SoC) lower than a preset second minimum reference value among all vehicles, to the second minimum reference value.

The controller 100 may move the pick-up requested vehicle to a pick-up zone by using the parking robot.

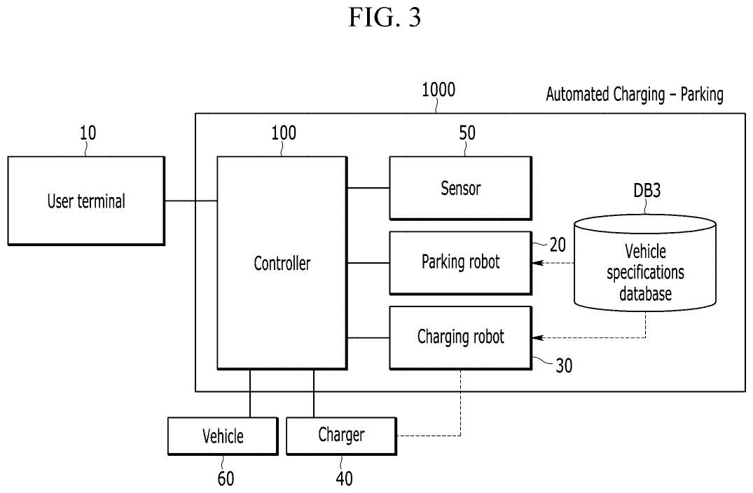

FIG. 3 is a block diagram of a robot-based electric vehicle parking and charging management apparatus according to another embodiment of the present disclosure.

FIG. 3 shows a block diagram with respect to a robot-based electric vehicle parking and charging management apparatus according to another embodiment providing the robot-based unmanned parking and charging service with respect to the vehicles provided for the car sharing or vehicle rent service.

In FIG. 3, the robot-based electric vehicle parking and charging management apparatus 1000 may provide an automated parking and automated charging service, in order to provide a car sharing and/or vehicle rent service.

The robot-based electric vehicle parking and charging management apparatus 1000 may provide only a dedicated vehicle 60 for providing the car sharing and/or vehicle rent service to the user. In other words, the robot-based electric vehicle parking and charging management apparatus 1000 only provides a vehicle available for the service, and accordingly the vehicle model database DB1 and the registered vehicle database DB2 storing the vehicle information of FIG. 2 are not required.

In addition, the robot-based electric vehicle parking and charging management apparatus 1000 provides dedicated vehicles, and the state of charge (SoC) information with respect to the dedicated vehicle may be inquired through vehicle linkage.

In other words, the controller 100 may be linked with the vehicle 60 or the dedicated vehicle 60 and may provide various information pieces including the vehicle information, the state of charge (SoC) information with respect to the dedicated vehicle 60, or the like.

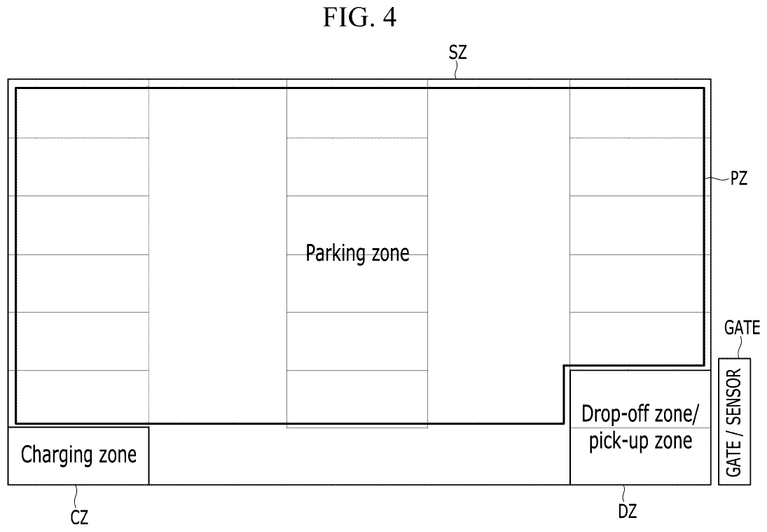

FIG. 4 is a drawing showing the service zone including the drop-off zone, the parking zone and a charging zone according to an embodiment.

Referring to FIG. 4, a service zone SZ may include a drop-off zone DZ, a parking zone PZ and a charging zone CZ. The service zone SZ may further include a gate. The gate may include a sensor for detecting an entry of the vehicle.

Sensors for detecting movement of the parking robot and the charging robot may be disposed within the service zone SZ. The sensor may include a hazard detection sensor.

The robot-based electric vehicle parking and charging management apparatus 1000 may manage and control the parking robot, the charging robot, and the sensors, in the service zone SZ.

The robot-based electric vehicle parking and charging management apparatus 1000 may automate parking and charging of a service vehicle having entered the service zone SZ.

Here, the service vehicle may mean a vehicle that is provided with the robot-based unmanned automated parking and charging service. The service vehicle may be the normal vehicle of the user registered for the service through an application. The service vehicle may correspond to a dedicated vehicle of a car sharing company or vehicle rental company.

The drop-off zone DZ may be an area where the entered vehicle is dropped off. Here, the term drop-off may mean triggering of providing the service. For example, when it is determined that the vehicle having entered the drop-off zone DZ is dropped off, the robot-based electric vehicle parking and charging management apparatus 1000 may dispose the parking robot.

The robot-based electric vehicle parking and charging management apparatus 1000 may park the vehicle, which is dropped off, by using the disposed parking robot. When needed, the robot-based electric vehicle parking and charging management apparatus 1000 may move the vehicle to the charging zone and charge the vehicle.

The drop-off zone DZ may be the pick-up zone. In other words, the drop-off zone DZ may be a pick-up area where the user picks up the vehicle when the service is completed. The user may request the pick-up through an interface of an application, may pick up the vehicle having arrived at the pick-up zone, and may leave the service zone SZ.

According to the pick-up request of the user, the robot-based electric vehicle parking and charging management apparatus 1000 may command the pick-up to the parking robot to move the vehicle to pick-up zone.

The parking zone PZ may be an area where the vehicle is parked. The parking zone PZ may be an area where the electric vehicle requiring charging may wait. The parking zone PZ may be an area where the vehicle completed with charging is parked.

The charging zone CZ may be an area where the charger is disposed. The robot-based electric vehicle parking and charging management apparatus 1000 may connect the charger to the vehicle by using the charging robot disposed in the charging zone CZ.

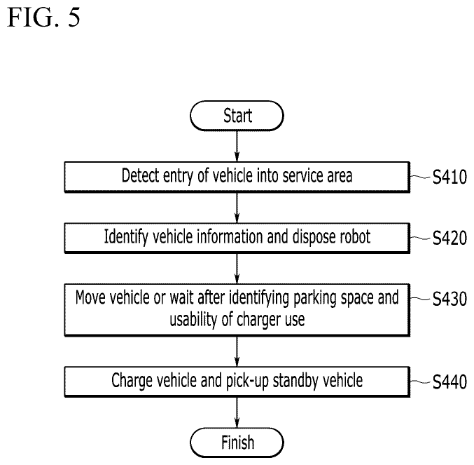

FIG. 5 is a flowchart of a robot-based electric vehicle parking and charging management method according to an embodiment. FIG. 5 shows a schematic sequence of a robot-based electric vehicle parking and charging management method according to an embodiment.

The robot-based electric vehicle parking and charging management method of FIG. 5 may be performed through the robot-based electric vehicle parking and charging management apparatus 1000 (see FIG. 2 and FIG. 3). For example, the robot-based electric vehicle parking and charging management method of FIG. 5 may be performed through the controller 100 (see FIG. 2 and FIG. 3).

In FIG. 5, at step S410, the robot-based electric vehicle parking and charging management apparatus 1000 may detect entry of the vehicle into the service area.

The robot-based electric vehicle parking and charging management apparatus 1000 may detect the vehicle entering the drop-off zone within the service zone through the sensor.

At step S420, the robot-based electric vehicle parking and charging management apparatus 1000 may dispose the robot and may identify the vehicle information.

The robot-based electric vehicle parking and charging management apparatus 1000 may identify the vehicle information with respect to the detected vehicle from the database and may determine whether the vehicle may be dropped off based on the identified vehicle information.

When the unmanned parking and charging service is provided to the normal vehicle, the robot-based electric vehicle parking and charging management apparatus 1000 may identify whether the vehicle has been registered. When the vehicle is registered, the robot-based electric vehicle parking and charging management apparatus 1000 may determine that the vehicle may be dropped off.

With respect to an unregistered vehicle, the robot-based electric vehicle parking and charging management apparatus 1000 may determine whether the drop-off is possible based on the vehicle information obtained from the user input and the database.

For example, the robot-based electric vehicle parking and charging management apparatus 1000 may determine whether the drop-off is possible through whether the vehicle specifications, including the vehicle type and specification, included in the vehicle information match the vehicle specifications capable of using the parking zone and the charging zone within the service zone.

At step S430, the robot-based electric vehicle parking and charging management apparatus 1000 may identify whether the parking space and the charger may be used and then may move the vehicle or may have the vehicle to wait.

The robot-based electric vehicle parking and charging management apparatus 1000 may identify the vehicle information from the database with respect to the vehicle dropped off in the drop-off zone. The robot-based electric vehicle parking and charging management apparatus 1000 may determine the parking space within the parking zone to move the vehicle based on the identified vehicle information and the parking zone map information.

The robot-based electric vehicle parking and charging management apparatus 1000 may move the vehicle to the determined parking space by using the parking robot. When the charger is in an occupied state, the robot-based electric vehicle parking and charging management apparatus 1000 may park and have the vehicle to wait in the parking area and may reserve the use of the charger.

When a charger within the charging zone is in a non-occupied state and there is no reservation of usage by another vehicle, the robot-based electric vehicle parking and charging management apparatus 1000 may issue a command to immediately move the dropped-off vehicle to the charging zone to the parking robot.

At step S440, the robot-based electric vehicle parking and charging management apparatus 1000 may charge the vehicle of the charging zone or may pick up the vehicle waiting in the parking zone.

The robot-based electric vehicle parking and charging management apparatus 1000 may charge the vehicle having arrived in the charging zone by using the charging robot. The robot-based electric vehicle parking and charging management apparatus 1000 may issue a command to connect the charger to the charging inlet of the vehicle to the charging robot. The charging robot may insert the charger into the charging inlet of the vehicle by using sensors and may start charging.

In order to move the vehicle waiting in the parking zone to the charging zone, the robot-based electric vehicle parking and charging management apparatus 1000 may pick up the waiting vehicle. According to the waiting vehicle pick-up command, the parking robot may transport the vehicle from the parking zone to the charging zone.

The robot-based electric vehicle parking and charging management apparatus 1000 may return the vehicle completed with charging from the charging zone to the parking zone.

In addition, the robot-based electric vehicle parking and charging management apparatus 1000 may move a vehicle of the parking zone to the drop-off zone or the pick-up zone according to the pick-up request of the user.

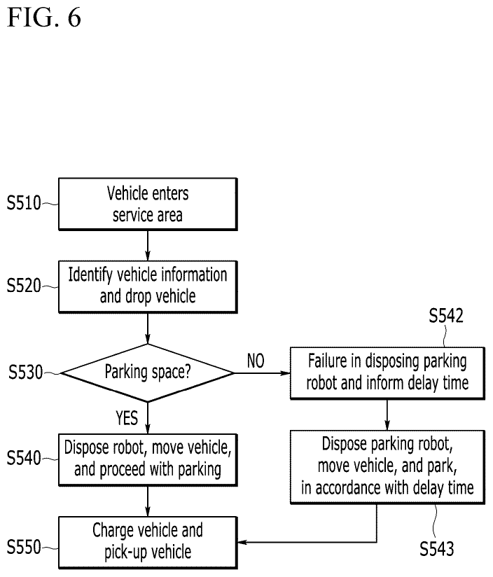

FIG. 6 is a flowchart of a robot-based electric vehicle parking and charging management method according to an embodiment. FIG. 6 shows a detailed flowchart of a robot-based electric vehicle parking and charging management method according to an embodiment.

The robot-based electric vehicle parking and charging management method of FIG. 6 may be performed through the robot-based electric vehicle parking and charging management apparatus 1000 (see FIG. 2 and FIG. 3). For example, the robot-based electric vehicle parking and charging management method of FIG. 6 may be performed through the controller 100 (see FIG. 2 and FIG. 3).

In FIG. 6, at step S510, the robot-based electric vehicle parking and charging management apparatus 1000 may detect entry of the vehicle into the service zone, which is the service area.

The robot-based electric vehicle parking and charging management apparatus 1000 may receive a drop-off request in the drop-off zone with respect to the user vehicle input through an interface of an application, from the user terminal.

At step S520, the robot-based electric vehicle parking and charging management apparatus 1000 may drop off the vehicle in the drop-off zone identify the detected vehicle information.

When the robot-based electric vehicle parking and charging management apparatus 1000 is operated by a car sharing or vehicle rental company, the vehicle information of the detected vehicle from the database may not be determined.

When the robot-based electric vehicle parking and charging management apparatus 1000 is operated by the car sharing or vehicle rental company, the vehicles entering and exiting the service zone may be specified as the dedicated vehicle for car sharing or vehicle rent.

Therefore, the robot-based electric vehicle parking and charging management apparatus 1000 may automatically detect the dedicated vehicle and drop off the dedicated vehicle.

When a company providing the automated parking and charging service to the normal vehicle operates the robot-based electric vehicle parking and charging management apparatus 1000, the robot-based electric vehicle parking and charging management apparatus 1000 may determine whether the detected normal vehicle is registered for the service.

When the vehicle is not registered for the service, the robot-based electric vehicle parking and charging management apparatus 1000 may determine the vehicle information including type and specifications of the vehicle from the database.

The robot-based electric vehicle parking and charging management apparatus 1000 may determine whether the drop-off is possible based on the vehicle information.

In the case of the vehicle registered for the service, the robot-based electric vehicle parking and charging management apparatus 1000 may determine that the vehicle may be dropped off.

The robot-based electric vehicle parking and charging management apparatus 1000 may determine whether there is a remaining parking space within the parking zone that may be used by the registered vehicle based on the registered vehicle information with respect to the registered vehicle and the parking zone map information.

At step S530, the robot-based electric vehicle parking and charging management apparatus 1000 may determine whether there is a parking space in the parking zone.

At step S541, when there is the parking space (YES in S530), the robot-based electric vehicle parking and charging management apparatus 1000 may dispose the parking robot to the dropped-off vehicle and may park the vehicle in the parking space by using the parking robot.

At step S542, when there is not the parking space (NO in S530), the robot-based electric vehicle parking and charging management apparatus 1000 may not immediately dispose the parking robot but may delay the disposal of the parking robot until the parking space appears.

At step S542, the robot-based electric vehicle parking and charging management apparatus 1000 may inform the delay time for the disposal of the parking robot to the user through the application.

Afterwards, at step S543, the robot-based electric vehicle parking and charging management apparatus 1000 may dispose the parking robot in vehicle in accordance with the informed delay time and may move the vehicle to the parking zone by using the parking robot.

When disposing the parking robot, the robot-based electric vehicle parking and charging management apparatus 1000 may determine whether the charger of the charging zone may be used.

When the charger can be used, the robot-based electric vehicle parking and charging management apparatus 1000 may move the vehicle to the charging zone by using the disposed parking robot.

When the charger cannot be used, the robot-based electric vehicle parking and charging management apparatus 1000 may move the vehicle to the parking zone.

The parking robot may move underneath the vehicle dropped off in the drop-off zone and may load the vehicle onto the parking robot.

For example, a parking robot can have a plank shape that moves underneath a vehicle to lift the vehicle's wheels and place the vehicle on the parking robot.

The parking robot loaded with the vehicle may move to the parking space within the parking zone arranged for the corresponding vehicle.

The parking robot may unload the vehicle in the arrived parking space.

At step S550, the robot-based electric vehicle parking and charging management apparatus 1000 may move the parked vehicle to the charging zone and may charge the vehicle by using the charging robot.

The robot-based electric vehicle parking and charging management apparatus 1000 may provide the vehicle information including type and specifications of the vehicle determined from the database to the charging robot.

The charging robot may detect the position of the charging inlet of the vehicle based on the provided the vehicle information.

The charging robot may insert the charger into the charging inlet of the vehicle by using a sensor. When inserted into the charging inlet, the charger may detect the vehicle and start charging.

At step S550, when there is the pick-up request of the user with respect to the vehicle completed with charging, the robot-based electric vehicle parking and charging management apparatus 1000 may pick-up the vehicle and move it to the pick-up zone.

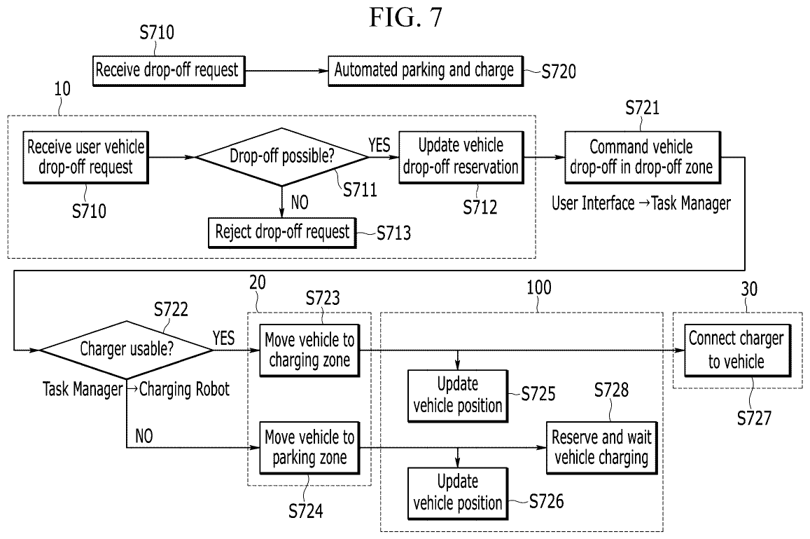

FIGS. 7-10 are drawings for explaining a robot-based electric vehicle parking and charging management method according to an embodiment.

The robot-based electric vehicle parking and charging management apparatus 1000 (see FIG. 2 and FIG. 3) may perform the robot-based electric vehicle parking and charging management methods of FIG. 7-FIG. 10. Hereinafter, description is made with reference to FIG. 2 and FIG. 3.

FIG. 7 shows a dropping-off and parking method of a vehicle according to an embodiment.

In FIG. 7, at step S710, the robot-based electric vehicle parking and charging management apparatus 1000 may receive the drop-off request from the user with respect to the vehicle having entered the drop-off zone.

At step S720, the robot-based electric vehicle parking and charging management apparatus 1000 may provide the automated parking and the charging service with respect to the dropped-off vehicle.

When the drop-off request requested by the user is received from the user terminal 10, at step S711, the robot-based electric vehicle parking and charging management apparatus 1000 may determine whether the drop-off is possible.

When the vehicle can be dropped off (YES at step S711), the robot-based electric vehicle parking and charging management apparatus 1000 may determine or reserve the vehicle drop-off. At step S712, the robot-based electric vehicle parking and charging management apparatus 1000 may update the confirming or reservation of the drop-off to the application of the user terminal 10.

When the vehicle cannot be dropped off (NO at step S711), at step S713, the robot-based electric vehicle parking and charging management apparatus 1000 may provide a message for rejecting the drop-off request to the user terminal 10.

For example, when the vehicle is a non-registered vehicle that does not have appropriate vehicle specifications or is not a service-dedicated vehicle, the robot-based electric vehicle parking and charging management apparatus 1000 may reject the drop-off request.

When the drop-off is determined, the robot-based electric vehicle parking and charging management apparatus 1000 may command the drop-off of the vehicle in the drop-off zone and may start the automated parking and charging service (S721).

At step S722, when the vehicle is dropped off, the robot-based electric vehicle parking and charging management apparatus 1000 may determine whether the charger of the charging zone may be used.

The robot-based electric vehicle parking and charging management apparatus 1000 may determine whether the charger may be used through the charging robot disposed in the charging zone.

At step S723, when there is a usable charger (YES in S722), the robot-based electric vehicle parking and charging management apparatus 1000 may move the vehicle to the charging zone by using the parking robot 20.

At step S724, when there is not a usable charger (NO in S722), the robot-based electric vehicle parking and charging management apparatus 1000 may move the vehicle to the parking zone by using the parking robot 20.

At step S725 and step S726, the robot-based electric vehicle parking and charging management apparatus 1000 may update the position of the vehicle in the controller 100.

At step S728, the robot-based electric vehicle parking and charging management apparatus 1000 may reserve and wait for the vehicle charge schedule, with respect to the vehicle having moved to the parking zone.

At step S727, with respect to the vehicle having moved to the charging zone, the robot-based electric vehicle parking and charging management apparatus 1000 may connect the vehicle to the charger and charge the vehicle by using the charging robot 30.

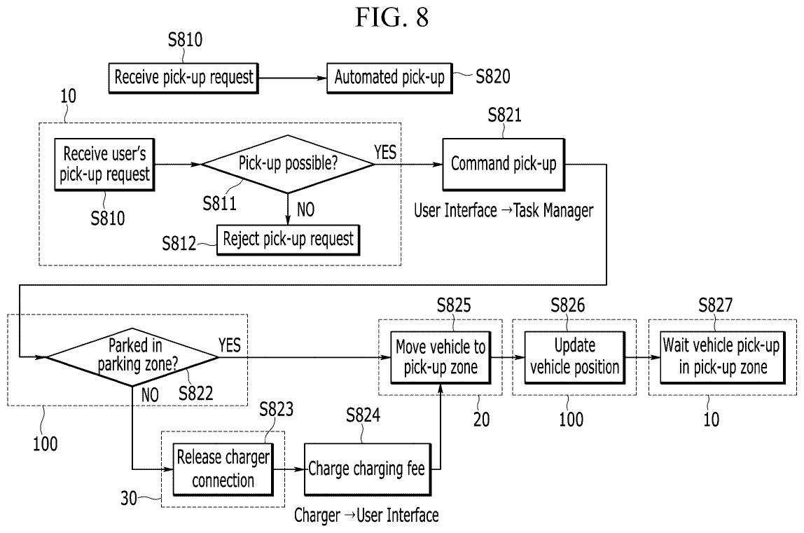

FIG. 8 shows a pick-up method of a vehicle according to an embodiment. At step S810, the robot-based electric vehicle parking and charging

management apparatus 1000 may receive the pick-up request of the vehicle from the user terminal 10.

At step S820, according to the pick-up request, the robot-based electric vehicle parking and charging management apparatus 1000 may provide the automated pick-up service with respect to the vehicle.

Here, the pick-up may mean returning of the user's vehicle that is parked and charged to the user. Alternatively, the pick-up may mean providing a vehicle to the user for providing the sharing or rental service with respect to the car sharing or rental service-dedicated vehicle.

According to the pick-up request, at step S811, the robot-based electric vehicle parking and charging management apparatus 1000 may determine whether the vehicle can be picked up.

When the pick-up is impossible (NO at step S811), at step S812, the robot-based electric vehicle parking and charging management apparatus 1000 may reject the pick-up request.

In the case of a car sharing or rental service-dedicated vehicle, the case where the pick-up is impossible may be the case where there is no other vehicle or there is not a sufficiently charged vehicle among remaining vehicles.

In the case of the user's vehicle for the parking or charging service, the case where the pick-up is impossible may be the case where the requested charging to the vehicle has not been completely performed.

At step S821, when the pick-up is possible (YES at step S811), the robot-based electric vehicle parking and charging management apparatus 1000 may command the pick-up with respect to vehicle to the parking robot.

At step S822, based on the pick-up command, the controller 100 may determine whether the vehicle is parked in the parking zone.

At step S823, when the vehicle is not in the parking zone but being charged in the charging zone (NO in S822), the charging robot 30 may release the connection of the charger from the vehicle.

At step S824, the robot-based electric vehicle parking and charging management apparatus 1000 may charge charging fee to the user through the user terminal.

At step S825, when the vehicle is parked in the parking zone (YES in S822), the robot-based electric vehicle parking and charging management apparatus 1000 may move the vehicle to the pick-up zone by using the parking robot 20.

At step S826, the robot-based electric vehicle parking and charging management apparatus 1000 may update the vehicle position to user terminal through the controller 100. The user may determine the position of the vehicle by using an interface provided in the application of the user terminal.

At step S827, the robot-based electric vehicle parking and charging management apparatus 1000 may have the vehicle wait in the pick-up zone. The user may pick up the vehicle waiting in the pick-up zone by using the interface of the user terminal 10.

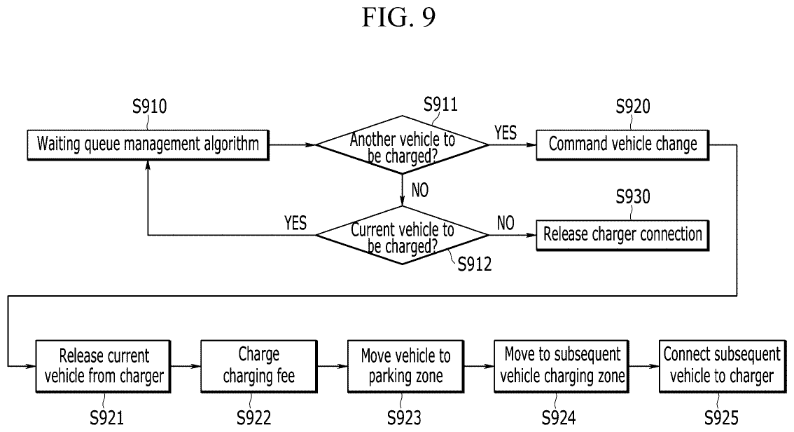

FIG. 9 shows a charging method of a vehicle according to an embodiment.

At step S910, the robot-based electric vehicle parking and charging management apparatus 1000 may charge the vehicle according to a charge sequence through a waiting queue management algorithm. At step S911, the robot-based electric vehicle parking and charging management apparatus 1000 may determine whether charging of another vehicle is necessary.

When charging of another vehicle is not necessary (NO at step S911), at step S912, the robot-based electric vehicle parking and charging management apparatus 1000 may determine whether the current vehicle needs charging according to the state of charge (SoC) of the current vehicle.

At step S930, when the current vehicle does not need charging more because the charging has been completed (NO at step S912), the robot-based electric vehicle parking and charging management apparatus 1000 may instruct the charging robot to release charger connection.

When more charging is still needed based on the state of charge (SoC) of the current vehicle (YES at step S912), at step S910, the robot-based electric vehicle parking and charging management apparatus 1000 may provide the state of charge (SoC) to the waiting queue management algorithm and maintain charging.

At step S920, when charging of another vehicle is required according to the waiting queue management algorithm (YES at step S911), the robot-based electric vehicle parking and charging management apparatus 1000 may command a change of vehicle to the charging robot. That charging of another vehicle is required may mean that, for example, a new vehicle has been newly dropped off in the drop-off zone.

For example, when it is determined that charging of another vehicle is necessary and charging of the current vehicle is sufficient, the robot-based electric vehicle parking and charging management apparatus 1000 may instruct a change of vehicle.

At step S921, the robot-based electric vehicle parking and charging management apparatus 1000 may command to release the connection of the charger from the current vehicle to the charging robot.

At step S922, the robot-based electric vehicle parking and charging management apparatus 1000 may charge the charging fee to the user through an application of the user terminal connected to the charger.

At step S923, the robot-based electric vehicle parking and charging management apparatus 1000 may move the vehicle to the parking zone by using the parking robot.

At step S924, the robot-based electric vehicle parking and charging management apparatus 1000 may dispose the parked vehicle as a subsequent vehicle according to a reserved charging schedule and move the parked vehicle to the charging zone.

At step S925, the robot-based electric vehicle parking and charging management apparatus 1000 may dispose the charging robot to the subsequent vehicle having arrived in the charging zone and may connect the charger.

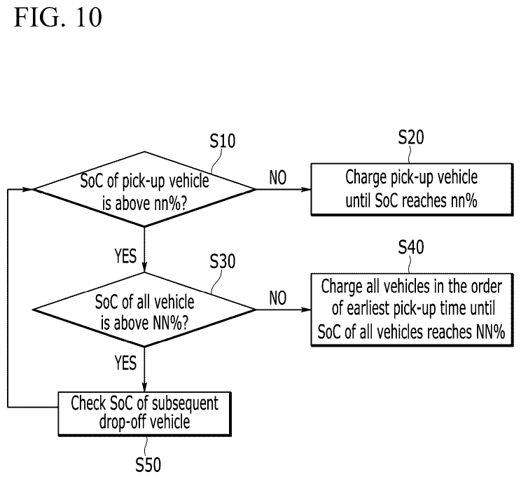

FIG. 10 shows a charging method according to an embodiment.

In an embodiment, the robot-based electric vehicle parking and charging management apparatus 1000 may determine the state of charge (SoC) with respect to the first pick-up vehicles scheduled for pick-up within a preset time among all vehicles in the service zone.

The robot-based electric vehicle parking and charging management apparatus 1000 may desirably charge, the second pick-up vehicle having the state of charge (SoC) lower than the preset first minimum reference value among the first pick-up vehicles, to the first minimum reference value.

When the second pick-up vehicle is not detected, the robot-based electric vehicle parking and charging management apparatus 1000 may determine the state of charge (SoC) with respect to all vehicles of the service zone.

The robot-based electric vehicle parking and charging management apparatus 1000 may desirably charge the specific vehicle having the state of charge (SoC) lower than the preset second minimum reference value among all vehicles, to the second minimum reference value.

In FIG. 10, at step S10, the robot-based electric vehicle parking and charging management apparatus 1000 may determine whether the state of charge (SoC) of the pick-up vehicle for which the pick-up is reserved is above a preset value nn %.

Here, the preset value nn % may be preset by the operator. For example, the preset value nn % may be 60-80%. The preset value nn % may be set as a minimum state of charge (SoC) required for providing the service with respect to car sharing or rental vehicle.

At step S20, the robot-based electric vehicle parking and charging management apparatus 1000 may desirably charge the vehicle having the state of charge (SoC) of the pick-up vehicle less than the preset value nn %, until the state of charge (SoC) reaches the preset value nn % when the state of charge (SoC) is not above the preset value nn % (NO in S10).

At step S30, when the state of charge (SoC) of the pick-up vehicles are all above nn % (YES in S10), the robot-based electric vehicle parking and charging management apparatus 1000 may determine whether the state of charge (SoC) of all vehicles is above a preset value NN % with respect to all vehicles within the service zone.

At step S40, the robot-based electric vehicle parking and charging management apparatus 1000 may charge at least one vehicle to the preset value NN % when the state of charge (SoC) of the at least one vehicle is not above the preset value NN %. At this time, at step S40, the robot-based electric vehicle parking and charging management apparatus 1000 may determine scheduled pick-up times for the vehicles and may desirably charge a vehicle whose scheduled pick-up time comes first. Here, the preset value NN % may be preset as the state of charge (SoC) that may be determined to have completed charging. For example, the preset value NN % may be 80%.

At step S50, when the state of charge (SoC) of all vehicles is determined to be above NN % (YES in S30), the robot-based electric vehicle parking and charging management apparatus 1000 may determine the state of charge (SoC) with respect to the subsequent dropped-off vehicle in the drop-off zone.

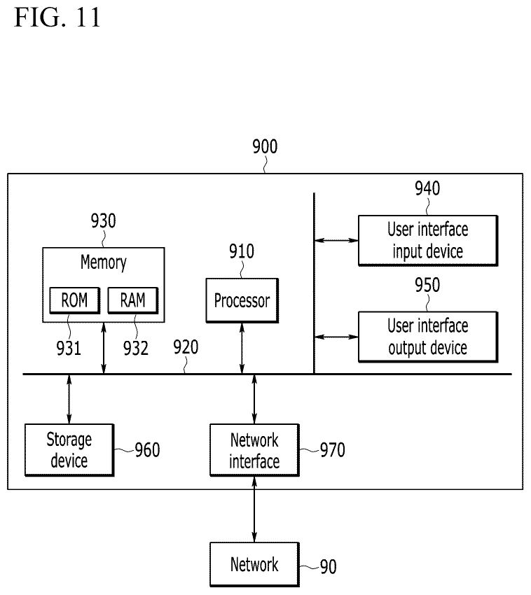

FIG. 11 is a drawing for explaining a computing device according to an embodiment.

Referring to FIG. 11, a robot-based electric vehicle parking and charging management apparatus and a robot-based electric vehicle parking and charging management method according to embodiments may be implemented by using a computing device 900.

The computing device 900 may include at least one of a processor 910, a memory 930, the user interface input device 940, the user interface output device 950, or a storage device 960 that communicate through a bus 920. The computing device 900 may also include a network interface 970 electrically connected to a network 90. The network interface 970 may transmit or receive signals with other entities through the network 90.

The processor 910 may be implemented in various types, such as a micro controller unit (MCU), an application processor (AP), a central processing unit (CPU), a graphic processing unit (GPU), a neural processing unit (NPU), and the like. The processor 910 may be any type of semiconductor device capable of executing instructions stored in the memory 930 or the storage device 960. The processor 910 may be configured to implement the functions and methods described above with respect to FIG. 1-FIG. 10.

The memory 930 and the storage device 960 may include various types of volatile or non-volatile storage media. For example, the memory may include read-only memory (ROM) 931 and a random-access memory (RAM) 932. In this embodiment, the memory 930 may be located inside or outside processor 910, and the memory 930 may be connected to the processor 910 through various known means.

In some embodiments, at least some configurations or functions of a robot-based electric vehicle parking and charging management apparatus and a robot-based electric vehicle parking and charging management method according to an embodiment may be implemented as a program or software executable by the computing device 900. The program or software may be stored in a computer-readable medium.

In some embodiments, at least some configurations or functions of a robot-based electric vehicle parking and charging management apparatus and a robot-based electric vehicle parking and charging management method according to an embodiment may be implemented by using hardware or circuitry of the computing device 900. Alternatively, the apparatus and the method may also be implemented as separate hardware or circuitry that may be electrically connected to the computing device 900.

While the present disclosure has been described with the embodiments, it should be understood that the present disclosure is not limited to the embodiments. On the contrary, the present disclosure is intended to cover various modifications and equivalent arrangements included within the spirit and scope of the appended claims.

### DESCRIPTION OF SYMBOLS

10: user terminal
20: the parking robot
30: the charging robot
40: charger
50: sensor
60: vehicle
100: controller
1000: robot-based electric vehicle parking and charging management apparatus

What is claimed is:

1. A robot-based electric vehicle parking and charging management apparatus, comprising:
a parking robot configured to move a vehicle dropped off in a drop-off zone to a parking zone or a charging zone;
a charging robot configured to charge the vehicle moved by the parking robot to the charging zone by connecting a charger; and
a controller configured to control a movement of the parking robot or an operation of the charging robot, according to a parking request or a charging request of a user of the vehicle.

2. The robot-based electric vehicle parking and charging management apparatus of claim 1, wherein the parking robot is further configured to:
load the vehicle dropped off in the drop-off zone;
move to a parking space arranged in the parking zone;
unload the vehicle in the parking space; and
return to the drop-off zone.

3. The robot-based electric vehicle parking and charging management apparatus of claim 1, wherein the parking robot is further configured to:
transport the vehicle completed with charging in the charging zone to the parking zone; and
transport the vehicle requiring charging from the parking zone to the charging zone.

4. The robot-based electric vehicle parking and charging management apparatus of claim 1, wherein, when the vehicle is dropped off in the charging zone, the charging robot is further configured to:
approach a position of a charging inlet of the vehicle based on information on the vehicle received from a database; and
insert the charger into the charging inlet of the vehicle by using a sensor.

5. The robot-based electric vehicle parking and charging management apparatus of claim 1, wherein, when an entry of the vehicle into the drop-off zone is detected through a sensor module, the controller is further configured to:
determine whether the vehicle is able to be dropped off; and
dispose the parking robot when determining that the vehicle is able to be dropped off.

6. The robot-based electric vehicle parking and charging management apparatus of claim 5, wherein the controller is further configured to:
when the vehicle entering the drop-off zone is detected, determine whether the vehicle is registered for a service; and
when the vehicle is not registered, determine vehicle information including type and specifications of the non-registered vehicle from a database and determine whether the non-registered vehicle is able to be dropped off based on the vehicle information.

7. The robot-based electric vehicle parking and charging management apparatus of claim 6, wherein when the vehicle is registered for the service, the controller is configured to:
determine that the registered vehicle is able to be dropped off; and
determine whether there is a remaining parking space within the parking zone usable by the registered vehicle based on registered vehicle information on the registered vehicle and parking zone map information.

8. The robot-based electric vehicle parking and charging management apparatus of claim 7, wherein, the controller is configured to:
when a remaining parking space for the registered vehicle and the non-registered vehicle is determined, dispose the parking robot to each of the registered vehicle and the non-registered vehicle; and
when the remaining parking space for the registered vehicle and the non-registered vehicle is not determined, inform a delay time to dispose the parking robot to the user.

9. The robot-based electric vehicle parking and charging management apparatus of claim 1, wherein the controller is further configured to:
determine a state of charge (SoC) with respect to first pick-up vehicles reserved for pick-up within a preset time among all vehicles within a service region; and
charge a second pick-up vehicle having the state of charge (SoC) lower than a preset first minimum reference value among the first pick-up vehicles to the preset first minimum reference value.

10. The robot-based electric vehicle parking and charging management apparatus of claim 9, wherein, when the second pick-up vehicle is not detected, the controller is further configured to:
determine the state of charge (SoC) with respect to all vehicles within the service region; and
charge a vehicle having the state of charge (SoC) lower than a preset second minimum reference value among all vehicles to the preset second minimum reference value.

11. A robot-based electric vehicle parking and charging management method, comprising:
detecting, by a sensor, a vehicle entering a drop-off zone;
determining whether the vehicle is able to be dropped off;
moving, by a parking robot, the vehicle determined to be able to be dropped off to a parking zone or a charging zone;
moving, by the parking robot, the vehicle parked in the parking zone to the charging zone;
charging, by a charging robot. a vehicle disposed in the charging zone by connecting a charger; and
returning, by the parking robot, the vehicle completed with charging to the parking zone.

12. The robot-based electric vehicle parking and charging management method of claim 11, further comprising receiving a drop-off request in the drop-off zone with respect to a user vehicle input through an interface of an application from a user terminal.

13. The robot-based electric vehicle parking and charging management method of claim 12, wherein determining whether the vehicle is able to be dropped off comprises:
determining whether the vehicle is registered for a service; and
determining vehicle information comprising type and specifications of the vehicle from a database and determining whether the vehicle is able to be dropped off based on the vehicle information, when the vehicle is not registered for the service.

14. The robot-based electric vehicle parking and charging management method of claim 13, wherein determining whether the vehicle is able to be dropped off further comprises:
determining that the vehicle is able to be dropped off, when the vehicle is registered for the service; and
determining whether there is a remaining parking space within the parking zone usable by the registered vehicle based on registered vehicle information on the registered vehicle and parking zone map information.

15. The robot-based electric vehicle parking and charging management method of claim 11, wherein moving, by the parking robot, the vehicle to the parking zone or the charging zone comprises:
moving the vehicle to the charging zone when the charger of the charging zone is usable; and
moving the vehicle to the parking zone when the charger of the charging zone is not usable.

16. The robot-based electric vehicle parking and charging management method of claim 11, further comprising:
identifying whether there is a parking space for the vehicle in the parking zone when it is determined that the vehicle is able to be dropped off;
disposing the parking robot to the vehicle when there is the parking space; and
informing a delay time to dispose the parking robot with respect to the vehicle when there is no parking space.

17. The robot-based electric vehicle parking and charging management method of claim 11, further comprising:
determining a state of charge (SoC) with respect to first pick-up vehicles reserved for pick-up within a preset time among all vehicles within a service region; and
charging a second pick-up vehicle having the state of charge (SoC) lower than a preset first minimum reference value among the first pick-up vehicles to the preset first minimum reference value.

18. The robot-based electric vehicle parking and charging management method of claim 17, further comprising:
determining the state of charge (SoC) with respect to all vehicles within the service region, when the second pick-up vehicle is not detected; and
charging a vehicle having the state of charge (SoC) lower than a preset second minimum reference value among all vehicles to the preset second minimum reference value.

19. The robot-based electric vehicle parking and charging management method of claim 11, wherein moving, by the parking robot, the vehicle to the parking zone or the charging zone comprises:
loading the vehicle dropped off in the drop-off zone by the parking robot;
moving the parking robot to a parking space within the parking zone arranged for the vehicle; and
unloading the vehicle in the parking space.

20. The robot-based electric vehicle parking and charging management method of claim 11, wherein charging, by the charging robot, the vehicle disposed in the charging zone to the charger by connecting the charger comprises:
receiving vehicle information comprising type and specifications of the vehicle from a database by the charging robot;
detecting a position of a charging inlet of the vehicle based on the vehicle information by the charging robot; and
inserting the charger into the charging inlet by using a sensor by the charging robot.
